(19) United States
(12) Patent Application Publication
(10) Pub. No.: US 2003/0097991 A1
(43) Pub. Date: May 29, 2003

(54) Device for taking a milk sample

(76) Inventors: Alexander Van der Lely, Na Rotterdam (NL); Renatus Ignatius Josephus Fransen, Zd Vlaardingen (NL)

Correspondence Address: Penrose Lucas Albright, Esq., Mason Mason & Albright, 2306 South Eads Street, PO Box 2246, Arlington, VA, 22202, US

(21) Appl. No.: 09/959,416

(22) Filed: Oct. 26, 2001

Related U.S. Application Data
(63) Continuation of application No. PCT/NL01/00093, filed on Feb. 5, 2001.

(30) Foreign Application Priority Data
Feb. 28, 2000 (NL) 1014508
Mar. 21, 2000 (NL) 1014710

(51) Int. Cl. A01J 3/00; A01J 5/00

(52) U.S. Cl. 119/14.14

(57) ABSTRACT

The invention relates to a device (3) for taking a milk sample, which device (3) is provided with a first milk sampling unit (4) and at least one further milk sampling unit (5), the device (3) comprising switch means (6) with the aid of which the supply of a sample liquid to the first milk sampling unit (4) can be switched over automatically or manually to a further milk sampling unit (5) or vice versa.

The invention relates to a device for taking a milk sample, which device is provided with a first milk sampling unit and at least one further milk sampling unit.

Such a device is known.

The invention aims at improving such a device.

According to the invention this is achieved in that the device comprises switch means with the aid of which the supply of a sample liquid to the first milk sampling unit can be switched over automatically or manually to a further milk sampling unit or vice versa. In particular when the switch means are controlled automatically, it is possible to increase the milk sampling capacity of the device without intervention of an operator. This is in particular of importance if the device is applied in an automatic milking implement which is provided with a milking robot.

According to a further inventive feature, the switch means comprise end control means with the aid of which the switch means are activated. In a first embodiment of the invention the end control means comprise a gear control which is provided with a pawl construction and a plate with at least two sectors. According to a further inventive feature, the sectors of the plate actuate a valve. According to again another inventive feature, the valve actuates a shut-off valve with the aid of which a milk sampling supply line to one of the milk sampling units is shut off. It will be obvious that the other supply line is then released. According to again another aspect of the invention, a controlled non-return valve is included between the valve and the shut-off valve. According to again another embodiment of the invention, the end control means comprise an end switch. According to a further inventive feature, the end switch comprises a valve. In a first embodiment of the invention the end switch is controlled mechanically. In a second embodiment of the invention the end switch is preferably actuated by an electronic counter.

The invention further relates to a switching device for being applied in a device as described above, said switching device being provided with switch means that switch over the supply of a sample liquid to a first milk sampling unit to a further milk sampling unit or vice versa.

The invention further relates to an implement for automatically milking animals, such as cows, provided with a milking robot for automatically connecting teat cups to the teats of an animal to be milked, characterized in that the implement is provided with a further device as described above.

The invention will now be explained in further detail with reference to the accompanying figures in which:

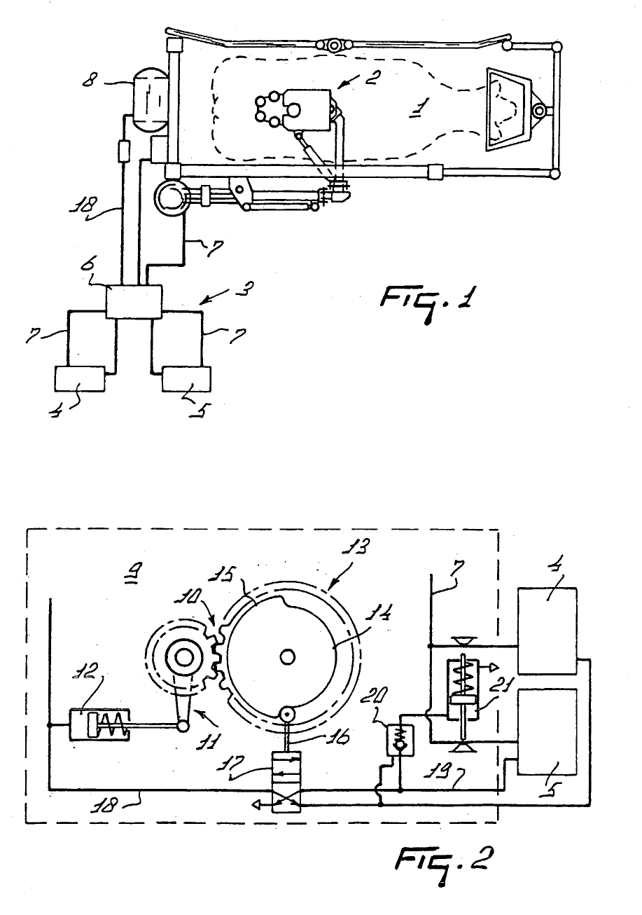

FIG. 1 is a plan view of a milk box with a milking robot and a device according to the invention;

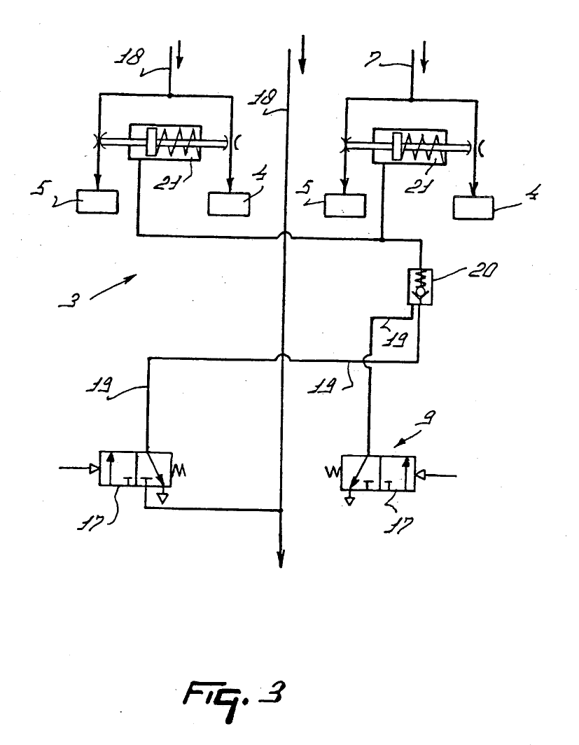

FIG. 2 shows a first embodiment of the device according to the invention;

FIG. 3 shows a second embodiment of the device according to the invention, and

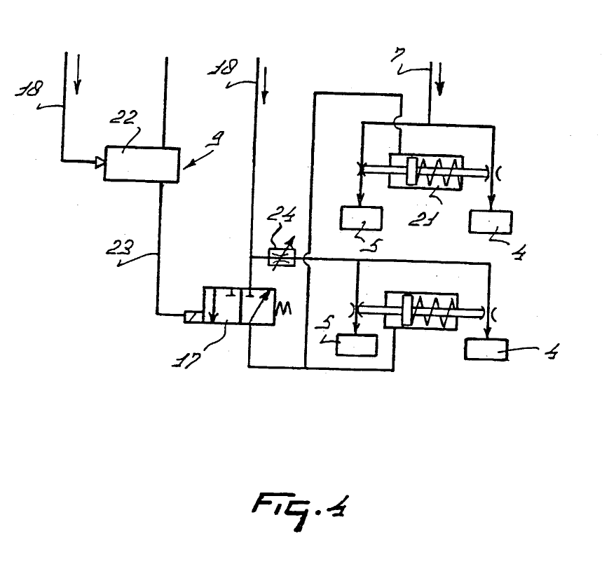

FIG. 4 shows a third embodiment of the device according to the invention.

FIG. 1 is a plan view of a milk box 1 with a milking robot 2 and a device 3 for taking a milk sample. The device 3 is provided with a first milk sampling unit 4 and a second milk sampling unit 5. The device 3 further comprises switch means 6 with the aid of which the supply of a sample liquid via supply lines 7 to the first milk sampling unit 4 can be switched over automatically to a second milk sampling unit 5 or vice versa. With the aid of the switch means 6 it is also possible to activate or to stop cooling means 8 for cooling the first and second milk sampling unit 4, 5. In the present embodiment the cooling means 8 are constituted by an air unit. However, it will be obvious that the cooling means 8 may also comprise an other type of cooling, such as e.g. a heat exchanger.

FIG. 2 shows a diagram of the switch means 6 with the aid of which the supply of a sample liquid to the first milk sampling unit 4 is switched over automatically to the second milk sampling unit 5. For that purpose the switch means 6 comprise end control means 9 which comprise a gear control 10 in the first embodiment. The gear control 10 is provided with a pawl construction 11 which is actuated by a first cylinder 12. In the present embodiment the first cylinder 12 is designed as a single-acting pneumatic cylinder with a drawback spring. The first cylinder 12 is actuated in a pulsating manner. The pulsation frequency is then equal to the frequency with which sampling takes place. So each time when a sample is taken the first cylinder 12 is activated. The pawl construction 11 further comprises a rotatable plate 13 which comprises a first sector 14 and a second sector 15. The plate 13 actuates a valve 17 via a pin 16. In the present embodiment the valve 17 is designed as a two-way valve. Just like the first cylinder 12, the valve 17 is connected, via a line 18, to a cooling system in the form of a compressed air unit 8 which also serves for cooling the two milk sampling units 4, 5. The milk sampling units 4, 5 are cooled via the lines 19. The valve 17 is connected to a shut-off valve 21 via the lines through a non-return valve 20 included therein. In the present embodiment the shut-off valve 21 is designed, just like the first cylinder 12, as a single-acting pneumatic cylinder with a drawback spring. However, it will be obvious that also any other type of shut-off valve with a similar function may be used. Depending on the position of the valve 17, the shut-off valve 21 shuts off the supply line 7 to one of the milk sampling units 4, 5. As shown in FIG. 2, the supply of sample liquid via the supply line 7 to the second milk sampling unit 5 is shut off. However, when a new sample is taken the plate 13 will rotate, as a result of which the pin 16 is pressed, whereupon the valve 17 is controlled, so that the shut-off valve 21 is activated, as a result of which the supply of sample liquid to the first milk sampling unit 4 is shut off and the supply to the second milk sampling unit 5 is released. At that moment also the cooling of the first milk sampling unit 4 is switched off and that of the second milk sampling unit 5 is switched on.

FIG. 3 shows a second embodiment of a device 3 according to the invention, in which parts corresponding to those of the embodiment of FIG. 2 are indicated by the same reference numerals. The device 3 according to the second embodiment also comprises control means 9 which are designed as two valves 17 in the present embodiment. At the moment when the last sample has been taken by the first milk sampling unit, the left hand valve 17 in FIG. 3 is automatically controlled. This may be effected mechanically or electronically. Via the line 18 compressed air then flows to the line 19 through the non-return valve 20 to the shut-off valves 21. The two shut-off valves 21 are controlled at the same time. The left hand shut-off valve 21 ensures that the cooling of the first milk sampling unit 4 is switched off and that of the second milk sampling unit 5 is switched on, while the right hand shut-off valve ensures that the supply line 7 for the sample liquid to the first milk sampling unit 4 is shut off and that to the second milk sampling unit 5 is opened. The non-return valve ensures that the shut-off valves 21 remain in their newly assumed position. When the last sample has been taken by the second milk sampling unit 5, the right hand valve 17 is controlled automatically, as a result of which the line 19, which is in connection with the non-return valve 20, de-aerates the lines to the shut-off valves 21, as a result of which the latter ensure under spring action that the supply lines of both the cooling medium and the sample liquid to the second milk sampling unit 5 are shut and those to the first milk sampling unit 4 are opened.

FIG. 4 shows a third embodiment of the device according to the invention, in which parts corresponding to those of the first and second embodiment of the invention are indicated by the same reference numerals. The device 3 according to the third embodiment also comprises end control means 9 which comprise e.g. an electronic counter 22 in the present embodiment. However, it will be obvious that this may also be a mechanical counter. With the aid of the electronic counter 22 it is recorded how many samples have been taken by a particular milk sampling unit. This takes place on the basis of the air pulses which are supplied to the electronic counter 22 via the line 18. If a pre-set amount of samples has been taken, the electronic counter 22 supplies a signal to the valve 17 via a line 23. In this manner air can flow via the line 18 through the valve 17, as a result of which the shutoff valves 21 are controlled, in such a manner that the supply of the cooling medium and the sample liquid to the first milk sampling unit 4 is switched over to the second milk sampling unit 5. Due to the fact that a throttle valve 24 is included in the line 18, it is possible not to switch off the cooling of a milk sampling unit completely, but for e.g. 80%. In a preferred embodiment of the invention the throttle valve 24 is adjustable, so that the cooling capacity can be adjusted per milk sampling unit.

1. A device (3) for taking a milk sample, provided with a first milk sampling unit (4) and at least one further milk sampling unit (5), characterized in that the device (3) comprises switch means (6) with the aid of which the supply of a sample liquid to the first milk sampling unit (4) can be switched over automatically or manually to a further milk sampling unit (5) or vice versa.

2. A device as claimed in claim 1, characterized in that the switch means (6) comprise end control means (9) with the aid of which the switch means (6) are activated.

3. A device as claimed in claim 2, characterized in that the end control means (9) comprise a gear control (10) which is provided with a pawl construction (11) and a plate (13) with at least two sectors (14, 15).

4. A device as claimed in claim 3, characterized in that the sectors (14, 15) of the plate (13) actuate a valve (17).

5. A device as claimed in claim 3 or 4, characterized in that the valve (17) actuates a shut-off valve (21) with the aid of which a milk sampling supply line (7) to one of the milk sampling units (4, 5) is shut off.

6. A device as claimed in claim 5, characterized in that a controlled non-return valve (20) is included between the valve (17) and the shut-off valve (21).

7. A device as claimed in claim 2, characterized in that the end control means (9) comprise an end switch.

8. A device as claimed in claim 7, characterized in that the end switch comprises a valve (17).

9. A device as claimed in claim 7 or 8, characterized in that the end switch is controlled mechanically.

10. A device as claimed in claim 7 or 8, characterized in that the end switch is preferably actuated by an electronic counter (22).

11. A device as claimed in any one of the preceding claims, characterized in that, with the aid of the switch means (6), there are automatically actuated further means, such as e.g. registration means for registering the milk samples and/or control means for controlling further functions of the milk sampling units (4, 5) and/or cooling means (8) for cooling the milk sampling units (4, 5).

12. A device as claimed in claim 11, characterized in that the control means are controlled pneumatically and/or electrically.

13. A switching device for being applied in a device as described in any one of claims 1 to 12, said switching device being provided with switch means (6) that switch over the supply of a sample liquid to a first milk sampling unit (4) to a further milk sampling unit (5) or vice versa.

14. An implement for automatically milking animals, such as cows, provided with a milking robot (2) for automatically connecting teat cups to the teats of an animal to be milked, characterized in that the implement is provided with a further device as described in any one of claims 1 to 12.
